(19) United States
(12) Patent Application Publication
(10) Pub. No.: US 2011/0266277 A1
(43) Pub. Date: Nov. 3, 2011

(54) DUAL-ACCESS ELECTRICAL BOX

(76) Inventor: Barton L. Garvin, Western Springs, IL (US)

(21) Appl. No.: 13/098,219

(22) Filed: Apr. 29, 2011

Related U.S. Application Data
(60) Provisional application No. 61/329,524, filed on Apr. 29, 2010.

(51) Int. Cl. H02G 3/08

(52) U.S. Cl. 220/3.2

(57) ABSTRACT

A dual-access electrical box includes a duct having a longitudinal axis, a sidewall, a first end, and a second end. At least one first aperture is disposed through the sidewall and a plurality of second apertures is disposed through the sidewall. Each of the first apertures is generally smaller than each of the second apertures and a removable plug is disposed in at least one of the second apertures. The dual-access electrical box can be attached to a cover plate or an electrical device thereby enclosing the electric cables that course through or are attached therein.

### CROSS-REFERENCE TO RELATED APPLICATIONS

The present application claims priority from U.S. Provisional Patent Application Ser. No. 61/329,524, filed Apr. 29, 2010, which is hereby incorporated in its entirety.

### FIELD OF THE INVENTION

The present invention relates to the field of construction materials, and in particular to an electrical box. More specifically, the present invention relates to a dual-access electrical box having an interior that is accessible from more than one side of the electrical box.

### BACKGROUND OF THE INVENTION

An electrical box or junction box is a container used to conceal and isolate electrical cables and connections from their surrounding environment. Generally, electrical boxes have apertures disposed through their walls for receiving multiple conduits that cover such electrical cables or are such electrical cables that may be interconnected within the electrical box. Such interconnection facilitates a connection to other electrical devices, such as switches, wall outlets, or electrical devices (for example, light fixtures, alarms, cameras, and many more).

Time and effort may be saved by interconnecting electrical cables within electrical boxes in a controlled environment, such as, for example, a user's shop. Such pre-wiring of electrical boxes facilitates speedy installation at a construction site. Currently available electrical boxes restrict the ability of a technician to work inside such boxes when pre-wiring them. The volume of usable space within an electrical box may be relatively small given the number of cables and interconnections that it must fit. The new electrical box disclosed herein below facilitates more efficient wiring of such electrical boxes, irrespective whether prewiring them on a bench prior to installation or onsite when installing or repairing an electrical system in the context of construction.

### SUMMARY OF THE INVENTION

In one aspect of the present invention, a dual-access electrical box includes a duct having a longitudinal axis, a sidewall, a first end, and a second end. A pair of first apertures is disposed through the sidewall and a plurality of second apertures is disposed through the sidewall. Each of the first apertures is generally smaller than each of the second apertures and a removable plug is disposed in at least one of the second apertures.

In another aspect of the present invention, a dual-access electrical box includes a duct having a longitudinal axis, a sidewall, a first end, and a second end. A plurality of first apertures is disposed through the sidewall and a plurality of second apertures is disposed through the sidewall. Each of the first apertures is generally smaller than each of the second apertures and a removable plug is disposed in at least one of the second apertures.

In a further aspect of the present invention, a dual-access electrical box includes a duct having a longitudinal axis, a sidewall, a first end, and a second end. A plurality of apertures is disposed through the sidewall. A tab extends inwardly from the sidewall proximate the first end of the duct and a removable plug is disposed in at least one of the plurality of apertures.

In a yet further aspect of the present invention, a dual-access electrical box includes a duct having a longitudinal axis, a sidewall, a first end, and a second end. A plurality of apertures is disposed through the sidewall. A plurality of first tabs extends inwardly from the sidewall proximate the first end and a plurality of second tabs extends inwardly from the sidewall proximate the second end. Each of the first and second pluralities of tabs includes a threaded aperture disposed therethrough.

In a still further aspect of the present invention, a dual-access electrical box includes a duct having a longitudinal axis, a sidewall, a first end, and a second end. A pair of first apertures is disposed through the sidewall and a plurality of second apertures is disposed through the sidewall. The dual-access electrical box further includes a cover member. Each of the first apertures is generally smaller than each of the second apertures and an attachment member attaches the cover member to the first end of the duct via the pair of first apertures.

In another aspect of the present invention, a dual-access electrical box includes a duct having a longitudinal axis, a sidewall, a first end, and a second end. A plurality of apertures is disposed through the sidewall and a tab extends inwardly from the sidewall proximate the first end of the duct. The dual-access electrical box further includes a cover member. A removable plug is disposed in at least one of the plurality of apertures and an attachment member attaches the cover member to the first end of the duct via the tab.

In a further aspect of the present invention, a dual-access electrical box includes a generally rectangular duct having a longitudinal axis, a sidewall, a first end, and a second end. A plurality of first apertures is disposed through the sidewall and a plurality of second apertures is disposed through the sidewall. A plurality of first tabs extends inwardly from the sidewall proximate the first end of the duct and a plurality of second tabs extends inwardly from the sidewall proximate the second end of the duct. Each of the first apertures is generally smaller than each of the second apertures and a removable plug is disposed in at least one of the second apertures.

In a yet further aspect of the present invention, a dual-access electrical box includes a generally octagonal duct having a longitudinal axis, a sidewall, a first end, and a second end. A plurality of first apertures is disposed through the sidewall and a plurality of second apertures is disposed through the sidewall. A plurality of first tabs extends inwardly from the sidewall proximate the first end of the duct and a plurality of second tabs extends inwardly from the sidewall proximate the second end of the duct. Each of the first apertures is generally smaller than each of the second apertures and a removable plug is disposed in at least one of the second apertures.

In a still further aspect of the present invention, a dual-access electrical box includes a generally square duct having a longitudinal axis, a sidewall, a first end, and a second end. A plurality of first apertures is disposed through the sidewall and a plurality of second apertures is disposed through the sidewall. A plurality of first tabs extends inwardly from the sidewall proximate the first end of the duct and a plurality of second tabs extends inwardly from the sidewall proximate the second end of the duct. Each of the first apertures is generally smaller than each of the second apertures and a removable plug is disposed in at least one of the second apertures.

In yet a further aspect of the present invention, a dual-access electrical box includes a generally hexagonal duct having a longitudinal axis, a sidewall, a first end, and a second end. A plurality of first apertures is disposed through the sidewall and a plurality of second apertures is disposed through the sidewall. A plurality of first tabs extends inwardly from the sidewall proximate the first end of the duct and a plurality of second tabs extends inwardly from the sidewall proximate the second end of the duct. Each of the first apertures is generally smaller than each of the second apertures and a removable plug is disposed in at least one of the second apertures.

In another aspect of the present invention, a dual-access electrical box includes a generally circular duct having a longitudinal axis, a sidewall, a first end, and a second end. A plurality of first apertures is disposed through the sidewall and a plurality of second apertures is disposed through the sidewall. A plurality of first tabs extends inwardly from the sidewall proximate the first end of the duct and a plurality of second tabs extends inwardly from the sidewall proximate the second end of the duct. Each of the first apertures is generally smaller than each of the second apertures and a removable plug is disposed in at least one of the second apertures.

In yet another aspect of the present invention, a dual-access electrical box includes a duct having a longitudinal axis, a sidewall, a first end, and a second end. A plurality of apertures is disposed through the sidewall and a tab extends inwardly from a portion of the interior periphery of the sidewall proximate the first end of the duct. A removable plug is disposed in at least one of the plurality of apertures.

In a further aspect of the present invention, a dual-access electrical box includes a generally square duct having a longitudinal axis, a sidewall, a first end, and a second end. A plurality of first apertures is disposed through the sidewall and a plurality of second apertures is disposed through the sidewall. A tab extends inwardly from a portion of the interior periphery of the sidewall proximate the first end of the duct. Each of the first apertures is generally smaller than each of the second apertures and a removable plug is disposed in at least one of the second apertures.

### BRIEF DESCRIPTION OF THE DRAWINGS

FIG. 1A is an isometric view of an embodiment of a dual-access electrical box.

FIG. 1B is a cross-sectional view of the dual-access electrical box of FIG. 1A taken generally along the lines 1B1-1B1 or 1B2-1B2 of FIG. 1A.

FIG. 1C is a side elevation of the dual-access electrical box of FIG. 1A.

FIG. 2A is an isometric view of another embodiment of a dual-access electrical box.

FIG. 2B is a cross-sectional view of the dual-access electrical box of FIG. 2A taken generally along the lines 2B1-2B1 or 2B2-2B2 of FIG. 2A.

FIG. 2C is a side elevation of the dual-access electrical box of FIG. 2A.

FIG. 2D is a cross-sectional view of an embodiment of a dual-access electrical box taken generally along the lines 2B1-2B1 of FIG. 2A.

FIG. 2E is a cross-sectional view of a further embodiment of a dual-access electrical box taken generally along the lines 2B1-2B1 of FIG. 2A.

FIG. 3A is an isometric view of a further embodiment of a dual-access electrical box.

FIG. 3B is a cross-sectional view of the dual-access electrical box of FIG. 3A taken generally along the lines 3B1-3B1 or 3B2-3B2 of FIG. 3A.

FIG. 3C is a side elevation of the dual-access electrical box of FIG. 3A.

FIG. 4A is a plan view and side elevation of the dual-access electrical box of FIG. 1A having a hexagonal shape.

FIG. 4B is a plan view and side elevation of the dual-access electrical box of FIG. 1A having an octagonal shape.

FIG. 4C is a plan view and side elevation of the dual-access electrical box of FIG. 1A having circular shape.

FIG. 5A illustrates the connection of a cover member to an embodiment of a dual-access electrical box via a fastener.

FIG. 5B is a cross-sectional view of an embodiment of a dual-access electrical box, taken generally along the lines 5B-5B of FIG. 3A and including an attached cover member.

FIG. 6A is a cross-sectional view of another embodiment of a dual-access electrical box, taken generally along the lines 5B-5B of FIG. 3A.

FIG. 6B is a cross-sectional view of the dual-access electrical box of FIG. 6A, taken generally along the lines 5B-5B of FIG. 3A and including two attached cover members.

FIG. 6C is a cross-sectional view of a further embodiment of a dual-access electrical box, taken generally along the lines 5B-5B of FIG. 3A.

FIG. 6D is a cross-sectional view of the dual-access electrical box of FIG. 6C, taken generally along the lines 5B-5B of FIG. 3A and including two attached cover members.

FIG. 6E is a cross-sectional view of another embodiment of a dual-access electrical box, taken generally along the lines 5B-5B of FIG. 3A.

FIG. 6F is a cross-sectional view of a further embodiment of a dual-access electrical box, taken generally along the lines 5B-5B of FIG. 3A.

FIG. 6G is a cross-sectional view of yet another embodiment of a dual-access electrical box, taken generally along the lines 5B-5B of FIG. 3A.

FIG. 6H is a cross-sectional view of the dual-access electrical box of FIG. 6E, taken generally along the lines 5B-5B of FIG. 3A and including two attached cover members.

FIG. 6I is a cross-sectional view of the dual-access electrical box of FIG. 6F, taken generally along the lines 5B-5B of FIG. 3A and including two attached cover members.

FIG. 6J is a cross-sectional view of the dual-access electrical box of FIG. 6G, taken generally along the lines 5B-5B of FIG. 3A and including two attached cover members.

FIG. 7A is a cross-sectional view of a further embodiment of a dual-access electrical box, taken generally along the lines 5B-5B of FIG. 3A and including two attached cover members.

FIG. 7B is a cross-sectional view of a still further embodiment of a dual-access electrical box, taken generally along the lines 5B-5B of FIG. 3A and including two attached cover members.

FIG. 7C illustrates the connection of a cover member to an embodiment of a dual-access electrical box via a snap fit attachment member.

FIG. 7D illustrates an embodiment of a cover member including inherently flexible snap fit attachment members.

FIG. 7E illustrates an embodiment of a cover member including spring-loaded snap fit attachment members.

### DETAILED DESCRIPTION OF THE PREFERRED EMBODIMENTS

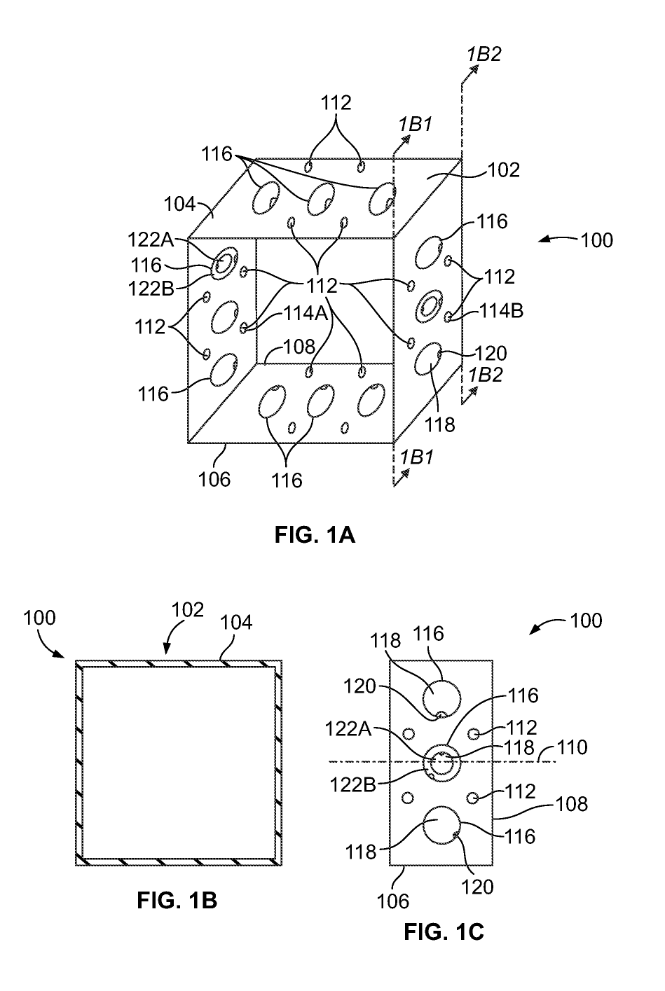

Referring now to the drawings wherein like numerals refer to like parts, FIGS. 1A-1C illustrate an embodiment of a dual-access electrical box 100 formed of a duct 102 having a sidewall 104, a first end 106, and a second end 108. The sidewall 104 defines a passageway having a generally uniform cross-sectional shape along a longitudinal axis 110 of the duct 102 between and including the first and second ends 106, 108. It is contemplated that the duct may have a cross-sectional area that is generally uniform along the longitudinal axis 110 between and including the first and second ends 106, 108. The duct 102 may also have a cross-sectional area that varies along the longitudinal axis 110 between and including the first and second ends 106, 108.

The first and second ends 106, 108 of the duct 102 have identical cross-sectional features when viewed along the longitudinal axis 110. FIG. 1B illustrates the cross-section of the duct 102 at both the first and second ends 106, 108. The sidewall 104 may comprise a single continuous member or may comprise a plurality of members that are joined to one another by welding, adhesives, fasteners, or any method of joining as known in the art. The sidewall 104 has a finite and generally uniform width and may be manufactured from any material as known in the art, for example, plastic, ferrous metal, non-ferrous metal, or fiberglass.

In this embodiment, there may be a single aperture, such as that depicted as 114A or 114B, or a plurality of first apertures as depicted as 112. Each of these apertures 112 is disposed through the sidewall 104. Each of the plurality of first apertures 112 may have a threaded interior or a smooth interior. Referring to FIG. 1A, the plurality of first apertures 112 may include a pair of first apertures 114A, 114B, wherein each of the first apertures 114A, 114B is disposed through the sidewall 104 in diametric opposition to the other.

It is the case that each of the plurality of first apertures 112 may have the same or different diameters such as may be suitable for a single electrical box to accommodate different dimensions of different fasteners, for example. Alternatively, or in addition, each of the plurality of first apertures 112 may have the same or different shapes (a circle, a triangle, a square, or other regular or irregular polygon, an ellipse, a linear slot, a bayonet slot, a crossed slot, and the like) to accommodate different fasteners or for other purposes. Generally, however, the purpose served by one or more of the apertures 112 is for attaching the dual-access electrical box 100 to a surface such as a stud that forms part of a wall. The plurality of first apertures 112 may be utilized for a variety of purposes as described further hereinbelow.

A plurality of second apertures 116 is disposed through the sidewall 104, as illustrated by FIGS. 1A and 1C. Each of the plurality of second apertures 116 is generally larger than each of the plurality of first apertures 112. The purpose generally served by one or more of the apertures 116 is to accommodate access from the outside to the inside of the electrical box 100 by an electrical cable, meaning one or more electrical cables outside of the electrical box that may be free or encased within a conduit. One or more of the plurality of second apertures 116 may include a removable plug 118. As illustrated in FIGS. 1A-1C, the plug 118 may be attached to the sidewall 104 by attaching elements 120. The removable plug 118 may further comprise an inner plug 122A that is removable from an outer plug 122B to allow the user a choice of aperture sizes. The plurality of second apertures 116 accommodating the plugs 118, 122A, 122B, as described hereinabove, may be formed, for example, by stamping, or by other methods for creating the removable plug 118 as may be known in the art.

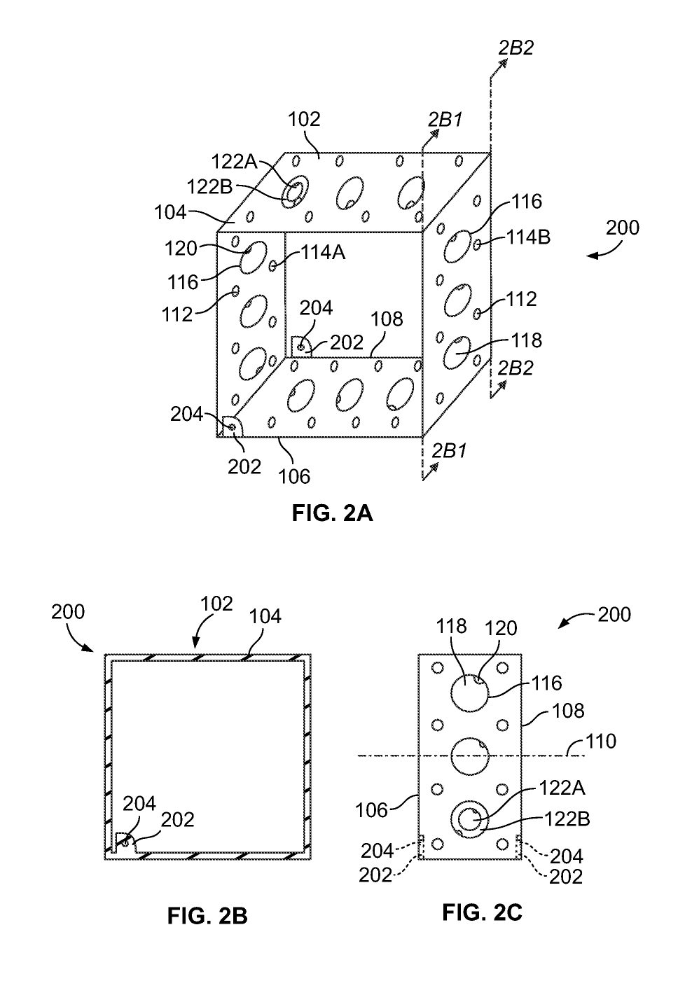

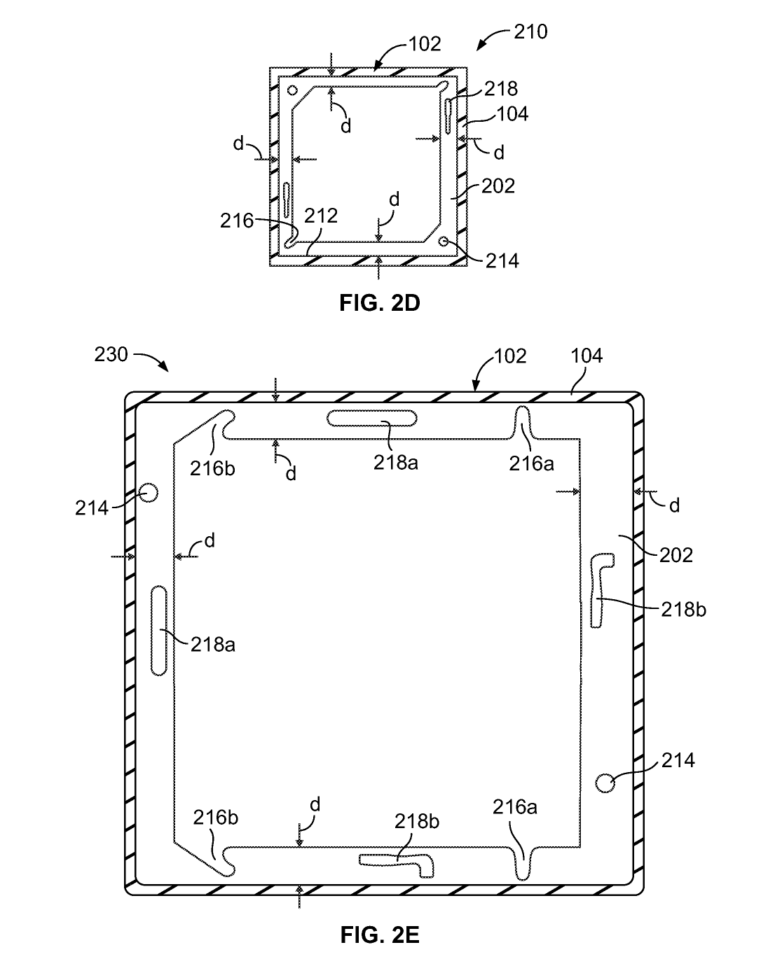

Referring to FIGS. 2A-2C, another embodiment of a dual-access electrical box 200 is illustrated. This embodiment includes all of the features of the dual-access electrical box 100 as described hereinabove with regard to FIGS. 1A-1C as well as additional features described below. A tab 202 extends inwardly from the sidewall 104 proximate the first end 106 of the duct 102. In addition or alternatively, a tab 202 extends inwardly from the sidewall 104 proximate the second end 108 of the duct 102. The tabs 202 are illustrated as generally rectangular and planar and lying in a plane generally perpendicular to the longitudinal axis 110. The tab 202 may be disposed at any position along the sidewall 104, for example, proximate to a corner of the sidewall 104, as illustrated in FIG. 2B.

Tabs 202 having other shapes and geometries of extension are also contemplated, such as, for example, a triangular, trapezoidal, circular, or other regularly or irregularly shaped tab (not shown). A tab 202 of any shape or dimension is suitably employed in the context of the present invention to the extent that it is able to receive a fastener. The tab 202 may include a third aperture 204 disposed therethrough. For example, as illustrated in FIG. 2C, the third aperture 204 is generally disposed longitudinally through the tab 202. The third aperture 204 is preferably a threaded aperture, but may be a smooth aperture.

Referring to FIG. 2D, another embodiment of a dual-access electrical box 210 includes a tab 202 that extends inwardly from a portion or all of the interior periphery 212 of the sidewall 104. For example, the tab 202 can extend inwardly from the entire interior periphery 212 of the sidewall 104, as illustrated in FIG. 2D. In embodiments that include a regular or irregular polygonal shape having one or more linear sides, the tab 202 may extend from part or all of one or more of the linear sides. For example, in an embodiment having a square or rectangular shape, the tab 202 may extend from part or all of one linear side, two linear sides, three linear sides or four linear sides. For embodiments having one or more curvilinear sides, the tab 202 may extend from part or all of one or more of the curvilinear sides.

Referring to FIG. 2D, in this embodiment, the dual-access electrical box 210 includes four sides and the tab 202 includes a region corresponding with and extending from the sidewall 104 at each of the four sides. At least a portion of each of the regions extends by about the same distance, d, from the sidewall 104 at each of the corresponding four sides. The distance, d, may be any distance suitably employed in the context of the present invention to the extent that it is able to receive a fastener. The tab 202 includes one or more third apertures 214 and/or one or more open ended slots 216 and/or closed slots 218 disposed therethrough. The third apertures 214 may be threaded or smooth.

Another embodiment of a dual-access electrical box 230 is illustrated in FIG. 2E. In this embodiment, the tab 202 extends by about the same distance, d, from each of the four sides and includes one or more third apertures 214 therethrough. This embodiment further includes open ended slots 216 and closed slots 218. The open ended and closed 216, 218 slots can have any shape or orientation that may be suitably employed in the context of the present invention to the extent that it is able to receive a fastener. For example, slots 216a are generally perpendicular to the sidewall 104, whereas slots 216b are disposed into the tab 202 non-orthogonally with respect to the sidewall 104. As a further example, slots 218a are generally linear and slots 218b are hooked such as, for example, bayonet slots.

Each tab 202 may be manufactured from any material as known in the art, for example, plastic, ferrous metal, non-ferrous metal, or fiberglass. The sidewall 104 and the tab 202 may comprise a single continuous member or may comprise a plurality of members that are joined to one another by a suitable joining method as known in the art, including by way of example and not limitation, welding, adhesives, fasteners, and the like. For example, the embodiments of the dual-access electrical box 210, 230 that include a tab 202 extending inwardly from a portion of the interior periphery 212 of the sidewall 104, the tab 202 may be manufactured integrally with one or more of the members that make up the sidewall 104. The tab 202 extending inwardly from a portion of the interior periphery 212 could also be manufactured in parts joined to a single continuous sidewall or to a sidewall comprising a plurality of members that are joined to one another as known in the art.

A cross-sectional footprint of the dual-access-electrical box 200 at the first end 106 includes the sidewall 104 and the position, size, and shape of the tab 202 including any third apertures 204, 214 or slots 216, 218 disposed therethrough that is attached proximate the first end as viewed looking at the dual-access electrical box 200 along the longitudinal axis 110 from the front end 106 toward the back end 108. Similarly, a cross-sectional footprint of the dual-access electrical box 200 at the second end 108 includes the sidewall 104 and the position, size, and shape of the tab 202 including any third apertures 204, 214 or slots 216, 218 disposed therethrough that is attached proximate the second end as viewed looking at the dual-access electrical box 200 along the longitudinal axis 110 from the front end 106 toward the back end 108. As illustrated in FIGS. 2A and 2B, the first and second ends 106, 108 of the dual-access electrical box 200 may have generally identical cross-sectional footprints when viewed along the longitudinal axis 110. Alternatively, the cross-sectional footprints of the dual-access electrical box 200 at the first and second ends 106, 108, may be generally mirror images of one another, may be rotated by a predetermined angle with respect to one another, or may not resemble one another.

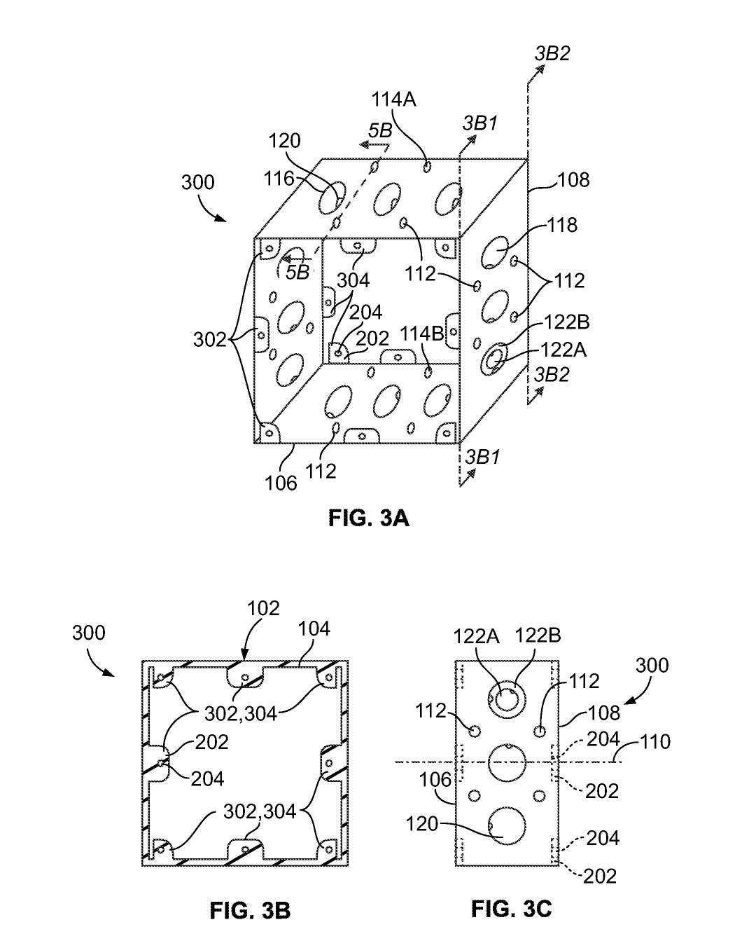

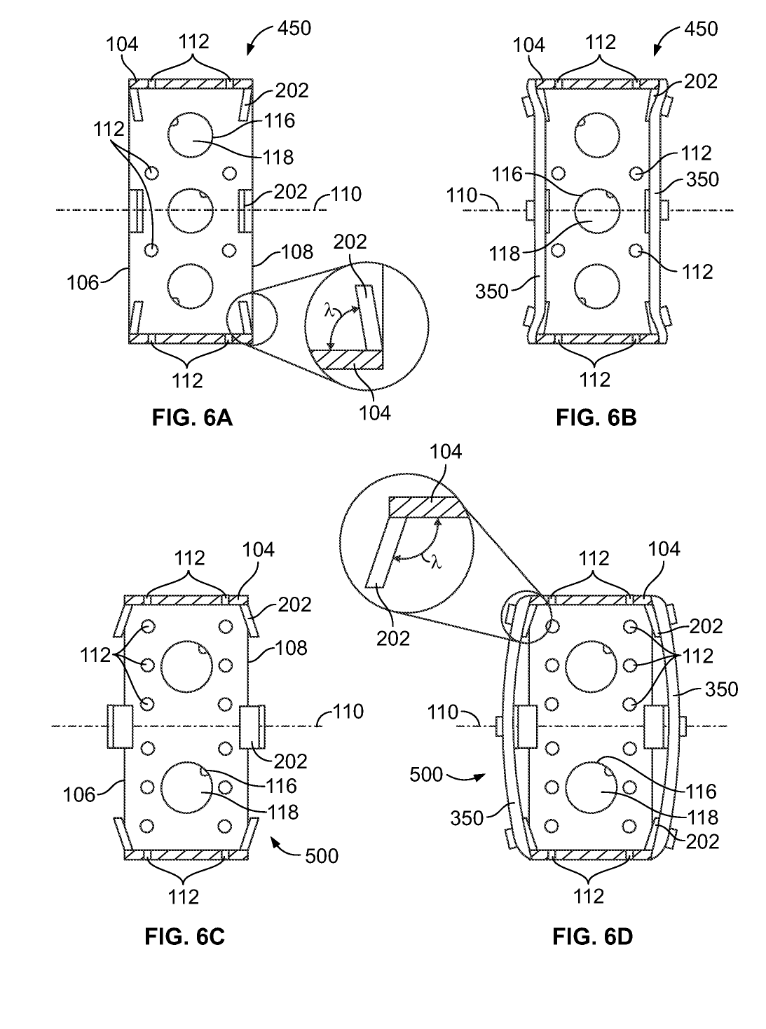

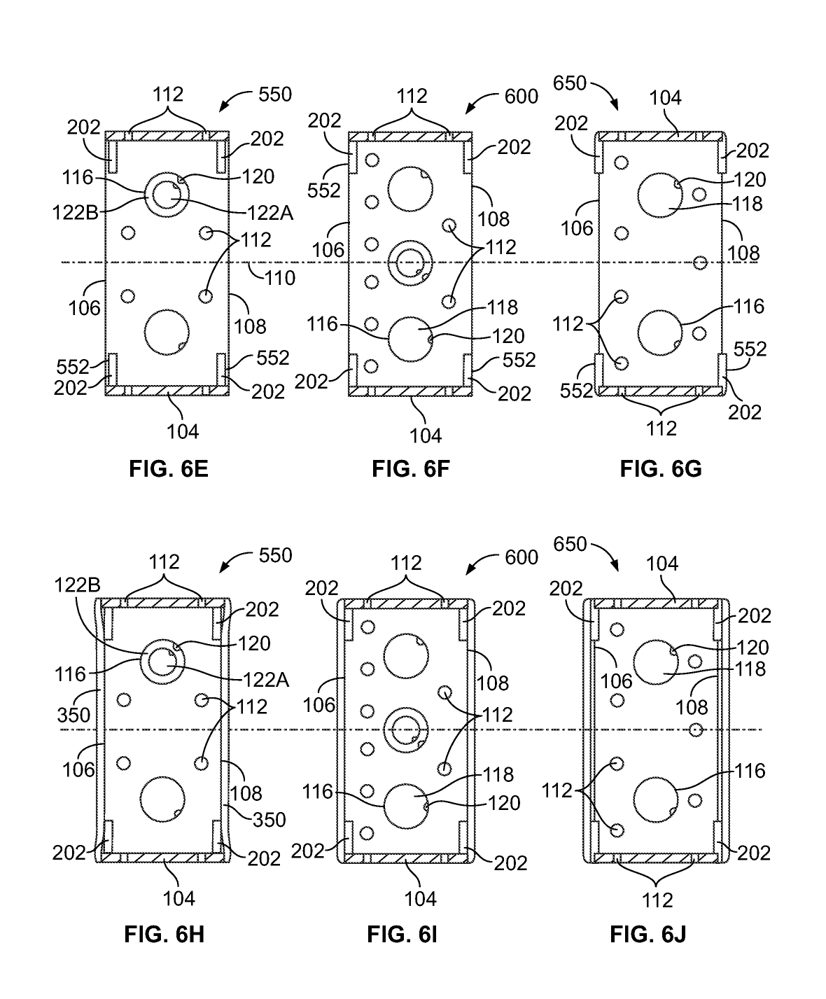

Referring to FIGS. 3A-3C, a further embodiment of a dual-access electrical box 300 is illustrated. This embodiment includes all of the features of the dual-access electrical boxes 200, 210, 230 as described hereinabove with regard to FIGS. 2A-2E as well as additional features described in the following. A plurality of first tabs 302 may extend inwardly from any position along the sidewall 104 proximate the first end 106 of the duct 102. A plurality of second tabs 304 may extend inwardly from any position along the sidewall 104 proximate the second end 108 of the duct 102. Each of the first and second pluralities of tabs 302, 304 may be any number of tabs 204 of two or more as desired or needed. In this embodiment, the electrical box 300 includes two to about ten tabs 204 disposed proximate one or both of the first and second ends 106, 108 of the duct 102. Each of the plurality of first tabs 302 and the plurality of second tabs 304 may have any size, shape, or orientation with respect to the sidewall 104 as described herein with regard to FIGS. 2A-2E and 6A-6D for a single tab 204.

As illustrated in FIGS. 3A and 3B, the first and second ends 106, 108 of the dual-access electrical box 300 may have generally identical cross-sectional footprints when viewed along the longitudinal axis 110. Alternatively, the cross-sectional footprints of the dual-access electrical box 300 at the first and second ends 106, 108, may be generally mirror images of one another, may be rotated by a predetermined angle with respect to one another, or may not resemble one another.

Other embodiments may have first and second ends 106, 108 that include symmetrically disposed or asymmetrically disposed cross-sectional features that make up their cross-sectional footprints. In yet another embodiment, cross-sectional footprints at the first and second ends 106, 108, include differing sets of cross-sectional features. In still other embodiments, the cross-sectional footprints differ between the first and second ends 106, 108 where the shapes and positions of the tabs 202 including any third apertures 204, 214 or slots 216, 218, for example, may be different on the first and second ends 106, 108, thereby lending a directional orientation to the first and second ends 106, 108 of the dual-access electrical box 200, 210, 230, 300.

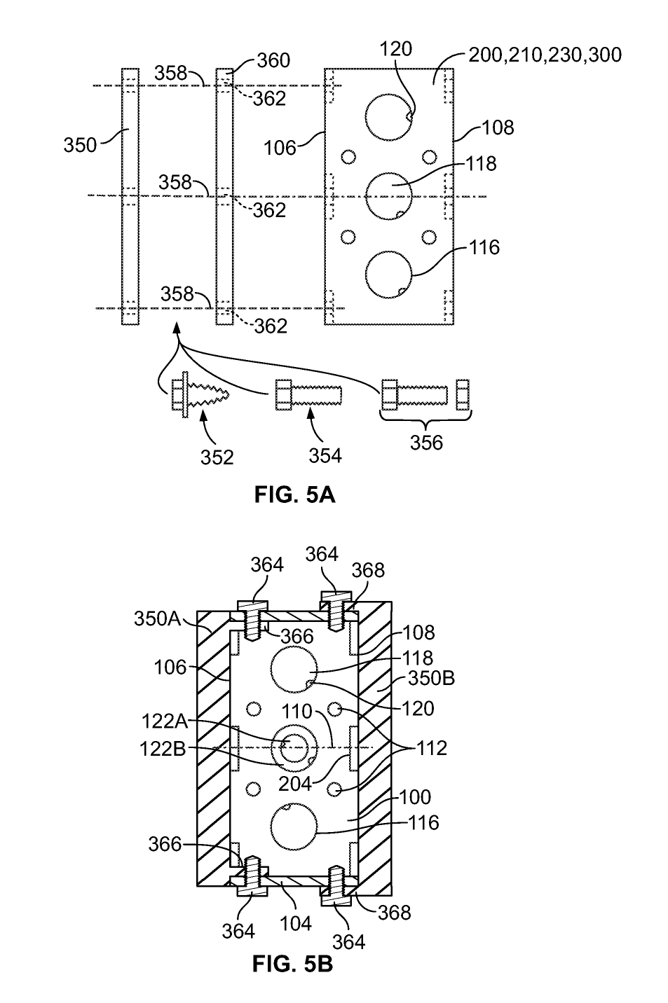

For example, with respect to the embodiments described hereinabove with regard to FIGS. 1A-3C, the first end 106 can include one or more first apertures 112 disposed through the sidewall 104 and may not include any tabs 202. The one or more first apertures 112 can be designed to accept a first cover member (see FIGS. 5A-7B) that would attach to the dual-access electrical box 100, 200, 210, 230, 300 via a snap fit of an attachment member(s) into the one or more of the first apertures 112. The second end 108, in contrast, can include one or more tabs 202 designed to accept a second cover member (see FIGS. 5A-7B) that would attach to the dual-access electrical box 200, 210, 230, 300 with, for example, a one-time use fastener that would have to be cut or mangled in order to remove the second cover member. Suitable one-time use fasteners include, for example, a rivet or a flexible flanged clip.

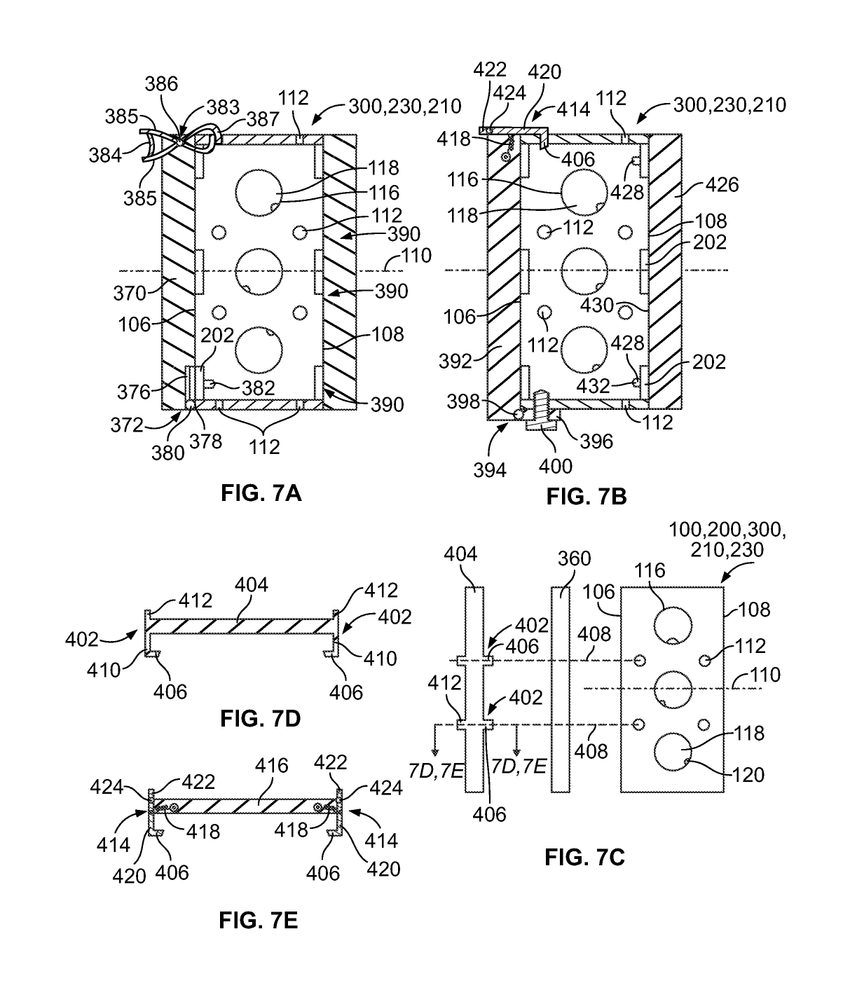

Referring to FIG. 3B, one or more pairs of the tabs 204 are diametrically opposed to one another within the duct 102. Diametrically opposed positions are those separated by 180 degrees of rotation about the longitudinal axis 110 of the duct 102. Diametric opposition of one or more pairs of the tabs 204 facilitates use of a uniformly designed cover member (see FIGS. 6A-7E) or other external component suitable for secure attachment to either end of the dual-access electrical box 300, as described herein.

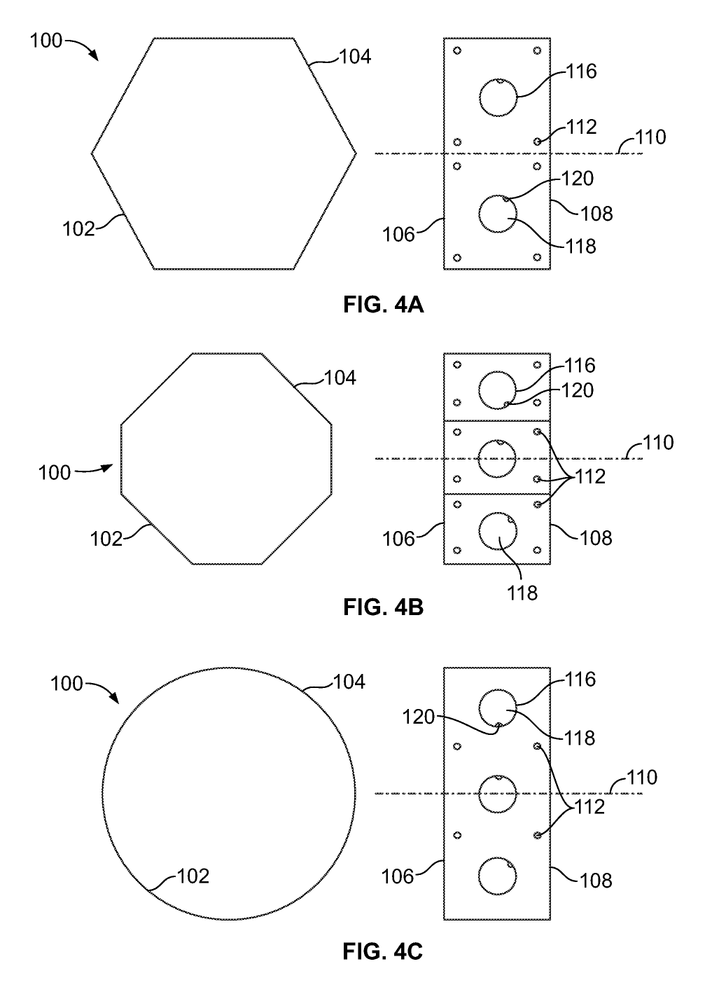

Despite the generic name of electric box or junction box for a container where electrical cables are joined one to another or to a switch or device, the dual-access electric box 100, 200, 210, 230, 300 of the present invention can describe any container shape. Reflecting the generic name, the duct 102 of the dual-access electrical boxes 100, 200, 210, 230, 300 (or others described but not shown) may have, for example, a generally square cross section, as shown in FIGS. 1A, 1B, 2A, 2B, 2D, 2E, 3A, and 3B. However, the duct 102 may have a cross-section that is any regular or irregular polygonal shape, for example, triangular, rectangular, square, pentagonal, hexagonal, heptagonal, octagonal, nonagonal, or decagonal, circular or ovoid, or may resemble a regular or irregular polygon having more than ten sides, or any shape as known in the art. For example, FIGS. 4A-4C illustrate ducts 102 that are hexagonal, octagonal, and round, respectively.

The length of the duct 102 may be a standard length as known in the art, for example, about 1.5 inches or about 2.125 inches measured between the first and second ends 106, 108. However, the duct 102 may have any non-standard length as desired or needed, for example, as short as 0.25 inches long, or as long as 12 inches or more.

Third apertures 204, 214 disposed through the tabs 202 (and the pluralities of first and second tabs 302, 304) may be utilized to attach the dual-access electrical box 200, 210, 230, 300 on either or both of the first and second ends 106, 108 to another electrical system component, for example, a currently available one-sided electrical box, a dual-access electrical box, a ring, an adapter plate, a cover member, or an electrical device such as, for example, a light fixture, an alarm, a camera, or any electrical device suitable for being attached to an electrical box as known in the art. Similarly, the plurality of first apertures 112 disposed through the sidewall 104 may be utilized to attach the dual-access electrical box 100, 200, 210, 230, 300 to another electrical system component or to a structural component, for example, a currently available one-sided electrical box, a dual-access electrical box, a ring, an adapter plate, a cover member, a wall stud, or a post.

A cover member 350 or other electrical system component may be attached to the electrical box 100, 200, 210, 230, 300 via the tabs 202, the first apertures 112, or a combination of the tabs 202 and the first apertures 112. The method of attachment may be any method known in the art, including by way of example and not limitation, a multi-use fastener, such as, for example, a screw or a bolt, a single-use fastener, such as a rivet, a clip, a snap fit, a hinge, an adhesive, or by combinations of these methods. The multi-use fastener, single-use fastener, clip, snap fit fastener, or hinge may be manufactured from any material as known in the art, including by way of example and not limitation, elastomeric material, plastic, ferrous metal, or non-ferrous metal.

For example, FIG. 5A illustrates attachment of the cover member 350 to the tabs 202 of the dual-access electrical box 200, 210, 230, 300 via a fastener, for example a sheet metal screw 352, a machine screw 354, a bolt and nut combination 356, or a rivet (not shown). The sheet metal screw 352 and/or the bolt and nut combination 356 may be appropriate for use with the third apertures 204 having a smooth bore, whereas the machine screw 354 may be appropriate for use with the third apertures 204 having a threaded bore. Dashed lines 358 indicate points of attachment between the cover member 350 and the dual-access electrical box 200, 210, 230, 300.

A gasket 360 may be disposed between the cover member 350 or other electrical system component or electrical device and the dual-access electrical box 100, 200, 210, 230, 300. The gasket 360 may include apertures 362 therethrough to accommodate fasteners or may be secured via an adhesive. The gasket 360 is manufactured from a compressible material that is generally compatible with any material from which the respective attachment surfaces of the dual-access electrical box 100, 200, 210, 230, 300 and a cover plate or other electrical system component or electrical device may be manufactured. Suitable compressible materials include cardboard, rubber, neoprene, and other synthetic or natural materials known in the art. The gasket 360 is adapted to provide an airtight and/or a watertight and/or a noise reducing seal between the dual-access electrical box 100, 200, 210, 230, 300 and the cover plate 350, electrical device, or other electrical system component attached thereto.

FIG. 5B illustrates attachment of a first cover member 350A via the first apertures 112 nearest the first end 106 of the dual-access electrical box 100, 200, 210, 230, 300 and a second cover member 350B via the first apertures 112 nearest the second end 108 of the dual-access electrical box 100, 200, 210, 230, 300. Fastener 364 in FIG. 5B represents any fastener known in the art, including by way of example and not limitation, a single-use fastener such as a rivet, or multiple-use fasteners such as the sheet metal screw 352, the machine screw 354, or the bolt and nut combination 356 discussed with regard to FIG. 5A. The cover member 350A includes cover tabs 366 that are configured to fit within the sidewall 104 whereas the cover member 350B includes cover tabs 368 that are configured to fit over an exterior of the sidewall 104.

In other embodiments, an angle formed between the tab 202 and the sidewall 104 may be acute or obtuse, including 180 degrees (not shown) wherein the tab 202 extends along the longitudinal axis 110. Referring to FIGS. 6A-6D, the angle between the tab 202 and the sidewall 104 angle may depart gently off the perpendicular. FIGS. 6A and 6B illustrate an embodiment of a dual-access electrical box 450 having the tabs 202 at an angle α that may, for example, be from about 70 degrees to about 85 degrees or more preferably from about 75 degrees to about 80 degrees. In FIGS. 6C and 6D an embodiment of a dual-access electrical box 500 includes the tabs 202 at the angle α that may, for example, be from about 95 degrees to about 110 degrees or more preferably from about 100 degrees to about 105 degrees.

FIGS. 6B and 6D illustrate that the tabs 202 can serve to attach an electrical system component, for example, the cover member 350, to the dual-access electrical boxes 450, 500 more tightly when the angle α is acute, i.e., less than 90 degrees, or less tightly when the angle α is obtuse, i.e., more than 90 degrees. For applications where an air-tight seal is desired, the tab 202 that describes an acute angle α relative to the sidewall 104 is well-suited for the purpose. For applications that may require passive or active cooling, the tab 202 that describes an obtuse angle α relative to the sidewall 104 is well-suited for the purpose. Nonetheless, use of suitable fasteners and, optionally, suitable gaskets (see FIGS. 5A, 5B) can serve to create an air-tight seal using the tab 202 that describes an obtuse angle α relative to the sidewall 104 as well.

In one embodiment of a dual access electrical box 550, each of the tabs 202 may extend inwardly from the sidewall 104 such the tab 202 includes an exterior surface 552 facing toward the first or second end 106, 108 of the duct 102 and disposed inside the first or second end 106, 108, as illustrated in FIGS. 6E and 6H. In another embodiment of a dual access electrical box 600, each tab 202 includes an exterior surface 552 disposed approximately coextensively with the first or second end 106, 108, as illustrated in FIGS. 6F and 6I. In a further embodiment of a dual access electrical box 650, the exterior surface 552 of each tab 202 is disposed outside the first or second end 106, 108, as illustrated in FIGS. 6G and 6J. In other embodiments, the exterior surface 552 of one or more of the tabs 202 may lie inside, outside, or coextensive with the first or second end 106, 108. For embodiments that include one or more tabs 202 that lie at an acute or obtuse angle relative to the sidewall 104, a portion or all of the exterior surface 552 may lie inside, outside, or coextensive with the first or second end 106, 108.

FIGS. 6H-6J illustrate that the tabs 202 can serve to attach an electrical system component, for example, the cover member 350, to the dual-access electrical boxes 550, 600, 650 more tightly when the exterior surface 552 is disposed inside the first or second end 106, 108, or less tightly when the exterior surface 552 is disposed outside the first or second end 106, 108. Tabs 202 that have the exterior surface 552 disposed inside the first or second end 106, 108 or coextensively with the first or second end 106, 108 are well-suited for applications where an air-tight seal is desired. Tabs 202 that have the exterior surface 552 disposed outside the first or second end 106, 108 are well-suited for applications that may require passive or active cooling. Nonetheless, use of suitable fasteners and, optionally, suitable gaskets (see FIGS. 5A, 5B) can serve to create an air-tight seal using the tab 202 having the exterior surface 552 disposed outside the first or second end 106, 108.

FIG. 7A illustrates attachment of a cover member 370 to the first end 106 of the dual-access electrical box 300 via a hinged attachment member 372, which includes first and second hinging members 376, 378 that pivot on a hinge pin 380. For a sidewall 104 that has a round cross-section when viewed end-on, a single hinged attachment member 374 may attach to the sidewall 104 at a tab 202 disposed at any position on the first or second end 106, 108 of the sidewall 104. If the sidewall 104 has linear portions in cross-section, for example, eight linear sides, six linear sides, or four linear sides as illustrated in FIGS. 3A and 7A, multiple hinged attachment members 372 may be attached across a linear portion at the tabs 202 extending therefrom. Alternatively, a single hingedly attached member 372 may span multiple tabs 202, attaching to one or more of the tabs 202 as desired or needed, and have a width as wide as the linear portion is long. The hinged attachment member 372 can attach to the one or more tabs 202 via fastener 382, which represents any fastener known in the art, including by way of example and not limitation, a single-use fastener such as a rivet, or multiple-use fasteners such as the sheet metal screw 352, the machine screw 354, or the bolt and nut combination 356 discussed with regard to FIG. 5A. A head of the fastener 382 (not shown) may be accommodated by a recess (not shown) in the hinging member 378 so as to not interfere with closing of the hinged attachment member 372.

A side of the cover member 370 opposite the hinged attachment member 374 may be attached to the first end 106 via a fastening clip as known in the art. For example, in one embodiment, a clip 383 may include a spring 384, for example, attached between clip arms 385 on a first side of a pivot point 386. The spring 384 provides a force to maintain closure of an end of the clip 383 opposite the spring 384. When so closed, engagement feet 387 may engage within the first aperture 112, as illustrated in FIG. 7A. Force applied to compress the spring 384 causes relative rotation of the clip arms 385 around the pivot point 386 and facilitates removal of the engagement feet 387 from the first aperture 112. It is contemplated that the clip 383, or a similar clip (not shown), may be sized to accommodate the width of a tab 202 and thereby be used to attach the cover member 370 to the dual-access electrical box 300 via one of the tabs 202. Note that the hinged attachment member 372 is not illustrated in cross-section in FIG. 7A because it lies behind the plane of cross-section.

FIG. 7A also illustrates a second cover member 388 attached to the second end 108 of the dual-access electrical box 300 via an adhesive 390. Suitable adhesives include polyurethanes, epoxies, and resins, for example, an acrylate resin, cyanoacrylate (commonly known as super glue). The adhesive 390 may be sparingly applied to a facing surface of the cover member 388 and/or to a facing edge of the second end 106 of the duct 102 around the sidewall 104 such that contact between the cover member 388 and the duct 102 results in a bond therebetween.

FIG. 7B illustrates attachment of a cover member 392 to a first aperture 112 proximate the first end 106 of the dual-access electrical box 300. Attachment is via a hinged attachment member 394, which includes a hinging member 396 pivotally attached to an edge of the cover member 392 at hinge pin 398. For a sidewall 104 that has a round cross-section when viewed end-on, a single hinged attachment member 394 may attach to the sidewall 104 at a first aperture 112 disposed at any position proximate to the first or second end 106, 108 of the sidewall 104. If the sidewall 104 has linear portions in cross-section, for example, eight linear sides, six linear sides, or four linear sides as illustrated in FIGS. 3A and 7B, multiple hinged attachment members 394 may be attached across a linear portions at the first apertures 112 disposed through the linear portion. Alternatively, a single hingedly attached member 394 may span multiple first apertures 112, attaching to one or more of the first apertures as desired or needed, and have a width as wide as the linear portion is long. The hinged attachment member 394 can attach to the one or more first apertures 112 via fastener 400, which represents any fastener known in the art, including by way of example and not limitation, a single-use fastener such as a rivet, or multiple-use fasteners such as the sheet metal screw 352, the machine screw 354, or the bolt and nut combination 356 discussed with regard to FIG. 5A.

A side of the cover member 392 opposite the hinged attachment member 394 may include an attachment member that snap fits to one or more of the first apertures 112 proximate the first end 106 of the dual-access electrical box 300. For example, FIG. 7C illustrates snap fit attachment members 402 associated with opposite sides of a cover member 404. A suitable snap fit attachment member 402, for example, could comprise a resilient or non-resilient spring-loaded attachment member having an inward or outward facing foot engagement 406 and extending from the cover member 404 or other electrical system component. As illustrated by the dashed lines 408 in FIG. 7C, the foot 406 snaps into an aperture when the cover member 404 is correctly positioned over a first or second end 106, 108 of the duct 102. FIG. 7C illustrates two resilient attachment members 402 disposed on a common side of the cover member 404. FIG. 7C further illustrates the inclusion of the optional gasket 360 between the cover member 404 and the dual-access electrical box 100, 200, 300.

Referring to FIG. 7D, in one embodiment, each snap fit attachment member 402 includes a body member 410 having the engagement foot 406 at a first end and a release tab 412 at a second end. The snap fit attachment members 402 may, for example, be inherently flexible clips that include sufficient elasticity to snap into the pair (114A, 114B) of apertures 112 and to be bent for removal from the first apertures 112 by force applied to the release tabs 412. For example, the engagement feet 406 may designed to snap into at least one pair (114A, 114B, see FIGS. 1A, 2A, 3A) of apertures of the plurality of first apertures 112 when the cover member 404 is forced against the first end 106 (or the second end 108) of the duct 102. The engagement feet 406 may be designed to, for example, enter the pair (114A, 114B) of apertures 112 from an exterior side of the duct 102 toward an interior side of the duct 102, or the engagement feet 406 may be designed to enter the pair (114A, 114B) of apertures 112 from an interior side of the duct 102 toward an exterior side of the duct 102.

Referring to FIG. 7E, another embodiment of snap fit attachment members includes spring-loaded attachment members 414 associated with opposite sides of a cover member 416. The spring-loaded attachment member 414 includes a spring 418 attached at a first end to the cover member 416 and at a second end to a body member 420. The body member 420 includes a first end having the engagement foot 406 and a second end having a release tab 422 and pivots around pin 424. The engagement foot 406 is designed to snap into one of the first apertures 112 when the cover member 416 is correctly positioned over an end of the duct 102. The release tab 422 facilitates removal of the engagement foot 406 from the first aperture 112. The spring-loaded attachment member 414 may be resilient or non-resilient, because a bias force produced by tension of the spring 418 maintains engagement of the engagement foot 406 within the first aperture 112.

Referring again to FIG. 7B, the side of the cover member 392 opposite the hinged attachment member 394 may be attached to the dual-access electrical box 300 via the spring-loaded attachment member 414 described with regard to FIG. 7E. FIG. 7B also illustrates a second cover member 426 attached to one or more of the tabs 202 proximate the second end 108 of the dual-access electrical box 300 via a snap fit. In this embodiment, one or more resilient members 428 extend from an interior surface 430 of the cover plate 426 at positions that correspond to the third apertures 204 disposed through the tabs 202. The resilient members 428 have distal ends that include knobs 432, which may be tapered on proximal and distal sides thereof, but include a central region that is larger in cross-section than the third apertures 204. When the resilient members 428 are forced through the third apertures 204, the knobs 432 are temporarily compressed in cross-section, but upon exiting the third apertures 204, the knobs expand and inhibit removal of the cover member 426.

It is contemplated that any of the above described electrical system components or devices may be attached to the dual-access electrical box 100, 200, 210, 230, 300, 450, 500, 550, 600, 650 as described hereinabove with regard to FIGS. 1A-7E. The cover member 350, 350A, 350B, 370, 390, 392, 404, 416, 426 or other electrical system component may be manufactured from material that is the same as or different from the material of the dual-access electrical box 100, 200, 210, 230, 300, 450, 500, 550, 600, 650 so long as the materials are compatible with one another or separated by the gasket 360, which is illustrated in FIGS. 5A and 7C. It is further contemplated that one or more of the tabs 202 and/or the sidewall 104, and/or the cover member 350, 350A, 350B, 370, 390, 392, 404, 416, 426 may be manufactured from a magnetic material. Such manufacture would facilitate easy positioning and installation of the dual-access electrical box 100, 200, 210, 230, 300, 450, 500, 550, 600, 650 on walls that are magnetically susceptible.

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

### INDUSTRIAL APPLICABILITY

A dual-access electrical box is presented that provides access to an interior thereof from two sides. The dual-access electrical box is designed to facilitate electrical system installation at a user's shop or in the context of construction when access from both sides after attachment of the electrical box to a structure at the construction site. Accordingly, the dual accessibility feature is contemplated to be predominantly used in the context of new construction after or upon initial framing but prior to dry wall installation. It is also contemplated to be useful in the context of remodeling and repairs where two-sided access into the electrical box is possible as well as in the context of pre-wiring boxes that are then brought to a construction site for faster installation as compared to having not pre-wired the dual-access electrical boxes. The dual-access electrical boxes may additionally be used to extend currently available electrical boxes.

While the present invention has been described with reference to its preferred embodiments, those of ordinary skill in the art will understand and appreciate that variations in materials, dimensions, geometries, and fabrication methods may be or become known in the art, yet still remain within the scope of the present invention.

I claim:

1. A dual-access electrical box, comprising:
a duct including a longitudinal axis, a sidewall, a first end, and a second end;
a pair of first apertures disposed through the sidewall; and
a plurality of second apertures disposed through the sidewall;
wherein each of the first apertures is generally smaller than each of the second apertures and a removable plug is disposed in at least one of the second apertures.

2. The dual-access electrical box of claim 1, further comprising a tab extending inwardly from the sidewall proximate the first end.

3. The dual-access electrical box of claim 1, wherein the duct includes a cross-sectional shape at the first end selected from the group of cross-sectional shapes consisting of: triangular, rectangular, square, pentagonal, hexagonal, heptagonal, octagonal, nonagonal, decagonal, circular, and any closed polygon having more than ten sides.

4. The dual-access electrical box of claim 1, wherein each of the first apertures is disposed through the sidewall in diametric opposition to the other, and wherein the pair of first apertures is adapted to receive attachment members.

5. The dual-access electrical box of claim 1, wherein the removable plug comprises an inner plug removable from an outer plug.

6. The dual-access electrical box of claim 1, wherein at least one of the first apertures has a threaded interior.

7. The dual-access electrical box of claim 1, further comprising a tab extending inwardly from the sidewall proximate the first end.

8. The dual-access electrical box of claim 1, wherein the plurality of first apertures comprises apertures of different shapes and sizes.

9. The dual-access electrical box of claim 1, wherein the sidewall comprises four sidewall members, wherein at least one of the sidewall members comprises first apertures having different shapes.

10. The dual-access electrical box of claim 1, wherein at least two of the first apertures are disposed through the sidewall in diametric opposition to each other.

11. A dual-access electrical box, comprising:
a duct including a longitudinal axis, a sidewall, a first end, and a second end;
a plurality of apertures disposed through the sidewall; and
a tab extending inwardly from the sidewall proximate the first end of the duct;
wherein a removable plug is disposed in at least one of the plurality of apertures.

12. The dual-access electrical box of claim 11, wherein the tab includes an aperture disposed therethrough.

13. The dual-access electrical box of claim 11, wherein the tab includes a threaded aperture disposed therethrough.

14. The dual-access electrical box of claim 11, wherein the duct includes a cross-sectional shape at the first end selected from the group of cross-sectional shapes consisting of: triangular, rectangular, square, pentagonal, hexagonal, heptagonal, octagonal, nonagonal, decagonal, circular, and any closed polygon having more than ten sides.

15. The dual-access electrical box of claim 12, further comprising a second tab extending inwardly from the sidewall proximate the first end.

16. The dual-access electrical box of claim 15, wherein a cross-sectional footprint of the dual-access-electrical box including the sidewall and the first named tab proximate the first end is generally identical to a cross-sectional footprint of the dual-access-electrical box including the sidewall and the second tab proximate the second end.

17. The dual-access electrical box of claim 11, further comprising a plurality of tabs extending inwardly from the sidewall proximate the second end.

18. The dual-access electrical box of claim 11, wherein the duct and the tab comprise a single continuous member.
